(19) United States
(12) Patent Application Publication
(10) Pub. No.: US 2006/0242346 A2
(43) Pub. Date: Oct. 26, 2006

(54) METHOD AND APARATUS FOR PLUG-AND-PLAY WEBSERVER

(75) Inventor: CORY THANG VUONG, SAN DIEGO, CA (US)

Correspondence Address: CORY THANG VUONG, PO BOX 910096, SAN DIEGO, CA, 92191-0096, US

(73) Assignee: CORY THANG VUONG, SAN DIEGO, CA (US)

(21) Appl. No.: 10/906,094

(22) Filed: Feb. 3, 2005

(51) Int. Cl. G06F 13/00

(52) U.S. Cl. 710/302

(57) ABSTRACT

Abstract of the Disclosure

A system, method and computer program for an apparatus is described. An apparatus is a very convenient, plug-and-play, ultra small, smart device that lets the end-users to host their websites at computer peripheral port. When said device is plugged in one of the computer peripheral ports: Universal Serial Bus (USB), Secure Digital Input and Output (SDIO), Compact Flash (CF), Cardbus, Peripheral Component Interconnect (PCI), PCI-Express, and ExpressCard; it shall function as a dedicated web hosting device powerful and robust enough to handle web hosting functions for Personal Home Page, File Transfer Protocol (FTP) Files Server, Streaming media, Common Gate Interface (CGI) scripts, Active Server Pages, or Game Server.

### Detailed Description of the Invention

### CROSS-REFERENCE(S) TO RELATED APPLICATIONS

This application is related to solely-owned, U.S. Patent application Ser. No. 60/522492, filed Oct 06, 2004 on behalf of inventor Cory Vuong, entitled HOSTSTICK DONGLE PLUG-AND-PLAY WEB SERVER, which is incorporated in its entirely by reference herein by reference for all purposes.

### TECHNICAL FIELD OF THE INVENTION

The present invention relates to internet communications at computer peripheral ports and, more particularly, a device capable of operating as a dedicated web hosting when is plugged in one of computer peripheral ports such as: Universal Serial Bus (USB), Secure Digital Input and Output (SDIO), Compact Flash (CF), Cardbus, Peripheral Component Interconnect (PCI), PCI-Express, and ExpressCard, etc.

### BACKGROUND OF THE INVENTION

The interfaces Universal Serial Bus (USB), Secure Digital Input and Output (SDIO), Compact Flash (CF), Cardbus, Peripheral Component Interconnect (PCI), PCI-Express, and ExpressCard are described in specifications available over the Internet at http://www.usb.org/, http://www.sdcard.org/, http://www.compactflash.org/, http://www.pcmcia.org/, http://www.pcisig.com/, http://www.expresscard.org/.

The Air interfaces WiMAX, Ultra Wide Band (UWB), Code Division Multiple Access (CDMA), Global System for Mobile Communication (GSM), and General Package Radio Service (GPRS) are described in specifications available over the Internet at www.ieee.org, www.cdg.org, www.etsi.org.

Free webpage services such as Geocities, which are very convenient but also have drawbacks. The first drawback is the lack of space. Most free services will limit the amount of storage space users can use which will pose a problem if they plan on having multimedia contents such as audio and video clips. Another drawback is that all of the free webpage services require users to place their banner ads on each page of their website. Some sites implant an advertising menu bar on their website instead of banners, which isn't much better. Even worse is the trend toward pop up ads. The final and most important drawback of these services is that users have domain names that are difficult to remember and find.

For larger websites with users’ own domain names, most users pay web hosting services to run their website. Basic packages are relatively costly for monthly services may range up to a couple hundred dollars and still get downtime whether it’ll be a few minute or a few hours at a time. It's just a fact of the business - downtime is inevitable. The better hosts have less down time, but this also means they cost more money.

Another disadvantage for paid web host is a customer’s website will reside on a server that has hundreds to thousands of other websites on it. For most situations, putting several websites on one web server is acceptable, but problems usually arise when the web host gets cheap and overloads the web server with way too many websites. This means that the customer’s website will slow down tremendously if another website on the same server gets really busy.

### GLOSSARY

Unless otherwise noted, or as may be evident from the context of their usage, any terms, abbreviations, acronyms or scientific symbols and notations used herein are to be given their ordinary meaning in the technical discipline to which the invention most nearly pertains. The following terms, abbreviations and acronyms may be used in the description contained herein:
ARM
Architecture Microprocessor
BT
Bluetooth
CAD
Computer Aids Design
CDMA
Code Division Multiple Access
CF
Compact Flash
CGI
Common Gate Interface
CPU
Central Processing Unit
CRC
Cyclic Redundancy Check
DMA
Direct Memory Access
DNS
Domain Name Service
ExpressCard
PCMCIA developed the ExpressCard standard to carry forward the benefits of 'plug-in' I/O cards to the next generation of personal computing devices.
FIFO
First-In First-Out
FLASH
Also known as Flash ROM. A form of EPROM based upon conventional UV EPROM technology but which is provided with a mechanism for electrically pre-charging selected sections of the capacitive storage array, thereby electively “erasing” all capacitive storage cells to a known state
FTP
File Transfer Protocol
GPRS
General Package Radio Service
GSM
Global System for Mobile Communication
GNU
GNU is a recursive acronym for “GNU's Not UNIX”. GNU is an operating system of Linux.
SPA
Shared Panel Application
HTTP
Hyper Text Transfer Protocol
IDE
Integrated Development Environment
I/O
Input and Output
IRQ
Interrupt Request
IMAP
Internet Message Access Protocol
IC
Integrated Circuit
IrDA
Infrared Data Association
IEEE
Institute Electrical and Electronics Engineering
LED
Light Emitting Diode
MIPS
Million Instruction Per Second
OSC
Crystal Oscillator
PC
Personal Computer
PCB
Printed Circuit Board
PCI
Peripheral Component Interconnect
PCMIA
Personal Computer Manufacturer Interface Adapter
Perl
Practical extraction and report Language
PLL
Phase Lock Loop
POP3
Post Office Protocol Version 3
PPM
Position Pulse Modulation
RISC
Reduced Instruction Set Computer (or Chip)
ROM
Read-Only Memory
SD
Secure Digital
SDIO
Secure Digital Input/Output
SMTP
Simple Mail Transfer Protocol
SoC
System On Chip
SPA
Shared Panel Application
SPI
Serial Peripheral Interface
SRAM
Static Random Access Memory
UI
User Interface
USB
Universal Serial Bus
UWB
Ultra Wide Band
VLIO
variable latency I/O
WBCP
Web-Based Control Panel
WCDMA
Wideband Code Division Multiple Access
WiMAX
A Wireless Networking Standard 802.16
WLAN
Wireless Local Area Network

### BRIEF DESCRIPTION (SUMARY) OF THE INVENTION

A need therefore exists for a plug-and-play device that provides dedicated Web Hosting functions without the above-described disadvantages and problems.

A method for a plug-and-play device to operate as a web hosting server when it is plugged in one of host computer peripheral ports such as: USB, SDIO, CF, Cardbus, PCI, PCI-Express, and ExpressCard, etc.

According to the invention, techniques are provided for a plug-and-play device to function as a dedicated web hosting server. These techniques are preferably implemented by combining a high-performance low-power CPU with various system peripherals such as memories SDRAM, FLASH, Codes, and one of the computer peripheral interfaces: USB, SDIO, CF, Cardbus, PCI, PCI-Express, and ExpressCard, etc.

An exemplary use for the device of the present invention may integrate one of the following companion IC chips such as: USB-to-Ethernet, SDIO-to-Ethernet, Cardbus-to-Ethernet, PCI-to-Ethernet, CF-to-Ethernet, and ExpressCard-to-Ethernet. The companion IC may be utilized in case a peripheral interface described above is not available in a micro-architecture CPU. Otherwise, code may be used in design to carried-out protocols conversion.

Methods employing the techniques of the present invention may include a system or subsystem having electrical functionality. Example systems such as: Cellular phones, Pocket PC, wireless Bluetooth (BT), Wireless Ultra Wide Band (UWB), Wireless Local Area Network (WLAN), WiMAX, General Package Radio Service (GPRS), and Code Division Multiple Access (CDMA). It is within the scope of the invention that such systems would benefit substantially from technique(s) of the present invention.

Other objects, features, and advantages of the invention will become apparent in light of the following description thereof.

### BRIEF DESCRIPTION OF THE DRAWINGS

Reference will be made in detail to preferred embodiments of the invention, examples of which are illustrated in the accompany drawings. The drawings are intended to be illustrated, not limiting. Although the invention will be described in the context of these preferred embodiments, it should be understood that it is not intended to limit the spirit and scope of the invention to these particular embodiments. Certain elements in selected ones of the drawings are illustrated not-to-scale, for illustrated clarity. Often, similar elements throughout the drawings are referred to by similar references numerals. For example, the element 200 may be similar in many respects to the element 300 in another figure.
FIG. 1a is a pictorial illustration of an USB device used in a discussion of the prior art.
FIG. 1b is a pictorial illustration of a CF device used in a discussion of the prior art.
FIG. 1c is a pictorial illustration of an SDIO device used in a discussion of the prior art.
FIG. 1d is a pictorial illustration of a PCI device used in a discussion of the prior art.
FIG. 1e is a pictorial illustration of a Cardbus device used in a discussion of the prior art.
FIG. 1f is a pictorial illustration of an ExpressCard device used in a discussion of the prior art.
FIG. 2 is a system block diagram of an USB device, according to the invention
FIG. 3 is a system block diagram of a Cardbus device, according to the invention
FIG. 4a is an illustration of an USB device plugging in a laptop’s USB port, according to the invention
FIG. 4b is an illustration of a CF device plugging in a handheld computing device’s CF port, according to the invention
FIG. 4c is an illustration of an SDIO device plugging in a handheld computing device’s SDIO port, according to the invention
FIG. 4d is an illustration of a PCI device plugging in a computer motherboard’s PCI port, according to the invention
FIG. 4e is an illustration of a Cardbus device plugging in a notebook computer’s Cardbus port, according to the invention
FIG. 4f is an illustration of an ExpressCard device plugging in a computer’s ExpressCard port, according to the invention
FIG. 5a is an illustration of a general purpose computer incorporating the technique(s) of the present invention
FIG. 5b is an illustration of a wireless telephone (cell phone) incorporating the technique(s) of the present invention

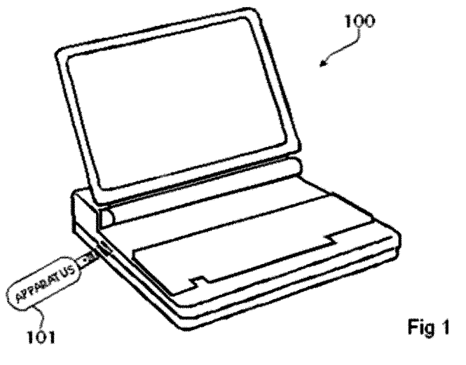

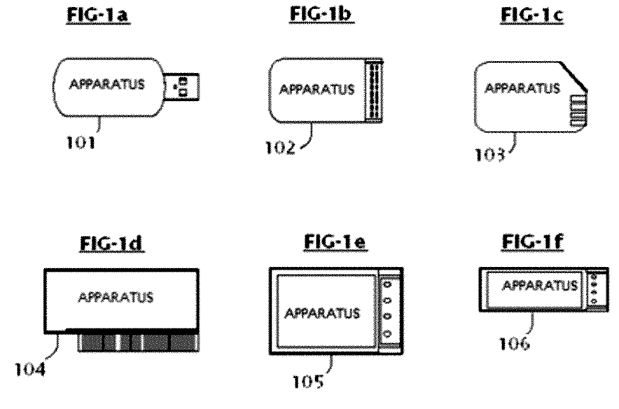

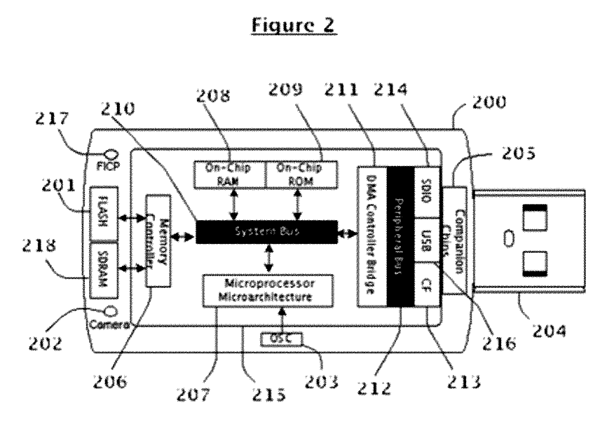

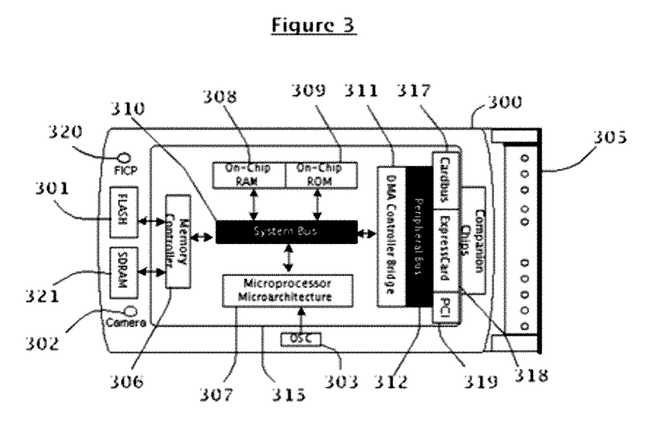

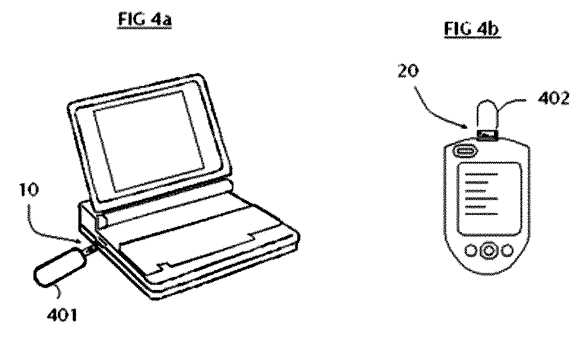

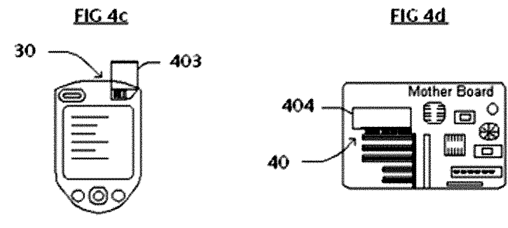

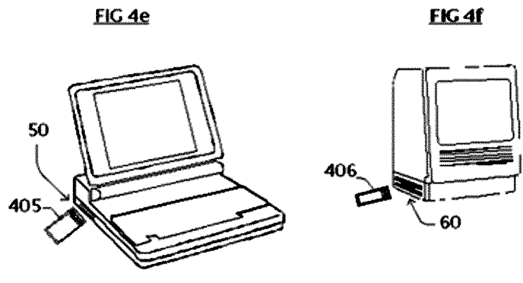

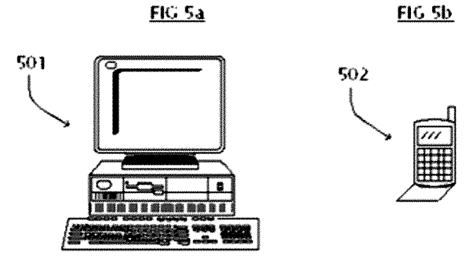

### DETAILED DESCRIPTION OF THE INVENTION

A device is a plug and play, tiny network-enabled capability device that functions as a dedicated web hosting server 101, 102, 103, 104, 105, 106 when is plugged in one of the following host computer ports: USB, SDIO, CF, Cardbus, PCI, PCI-Express, and ExpressCard, etc. The device contains a processor 215 that is a highly integrated system on a chip (SoC) included a high-performance low-power CPU 207, It also contains various system peripherals such as SDRAM 218, FLASH 201, Operating System, Linux or WinCE, and codes. To interface with host computer peripheral ports, the device must contains one of the following peripheral interfaces: USB 10, SDIO 30, CF 20, Cardbus 50, PCI, PCI-Express 40, and ExpressCard 60, etc. In case a peripheral interface described above is not available in the micro-architecture CPU 215, either a companion chip 205 or code may be utilized to carried-out protocol conversions. The device integrates processor 215 with its micro-architecture included other peripherals set as listed in the followings:
Memory Controller 206
Clock and Power Controllers 203
Universal Serial Bus Host/Client 216
SDIO (Secure Digital Input and Output) 214
CF (Compact Flash) 213
Fast Infrared Interface Communication Port (FICP) 217
Memory (On-chip RAM 208/ On chip ROM 209/ SDRAM 218/FLASH 201)
Companion IC 205
Codes

### MEMORY CONTROLLER

The Memory Controller 206 provides glue-less control signals with programmable timing for a wide assortment of memory-chip types and organizations. It supports SDRAM 218, RAM 208 partitions; static chip-selects for SDRAM 218, FLASH 201, ROM 209; it must supports at least one of the interfaced buses: USB 216, SDIO 214, CF 213, Cardbus 317, PCI/PCI-Express 319, and ExpressCard 318.

### CLOCK AND POWER CONTROLLERS

The processor’s 215 functional blocks are driven by high-speed clocks that are derived from an OSC crystal oscillation frequency 203. The OSC crystal 203 drives a core Phase Locked Loop (PLL) and a Peripheral PLL that produce selected clock frequencies to run particular functional blocks. Power management controls the transition between the turbo, run, idle, and sleep operating modes.

### UNIVERSAL SERIAL BUS (USB)

The USB Client and master Modules 216 are based on the Universal Serial Bus Specification, Revisions 1.1, 2.0 or higher. It supports up to sixteen endpoints and it provides an internally generated clock. The USB Device Controller provides First-in First-out (FIFOs) with DMA access to or from memory.

### SDIO (SECURE DIGITAL INPUT AND OUTOUT)

The SDIO block 214 is based on the industry SDIO card specifications revisions 1.0 or higher. The SDIO bus is a full speed I/O bus with low power consumption, which is allowed the device 403 to hot-plugged onto a portable hand-held device. The full-speed bus supports Serial Peripheral Interface (SPI), 1-bit SD and 4-bit SD transfer modes at the full clock range of 0-25 MHz.

### COMPACT FLASH (CF@$plus;) BLOCK

The CF+ block 213 is based on the industry CF+ card specifications version 2.1 or higher. The CF+ block 213 has a feature known as Multiword Direct Memory Access or DMA to the True IDE Mode of operation. It allows a Compact Flash block to transfer data directly to and from the host system memory without passing through the host system microprocessor 207. With the addition of the DMA feature, forward and backward compatibility is maintained and the CF+ block still provides a peak interface data transfer rate of 16MB per second.

### Fast Infrared Interface Communication Port (FICP)

The Fast Infrared Communications Port (FICP) 217 operates at half-duplex and provides direct connection to commercially available Infrared Data Association (IrDA) compliant LED transceivers. The FICP is based on the 4 Mbps Infrared Data Association (IrDA) standard1 and uses four-position pulse modulation (4 PPM) and a specialized serial packet protocol developed for IrDA transmission.

### MEMORY

The processor Integrates Memory Controller 206 with system bus 210 that including 16-bit, 32-bit, or 64-bit ROM 209, RAM 208, as well as USB 216, SDIO 214, CF 213, PCI/PCI-Express 319, Cardbus 317, and ExpressCard 318 for added functionality and expendability to the device applications. The external memory-bus interfaces for the processor support SDRAM 218 and FLASH 201 memories.

### COMPANION IC CHIPS

In case a peripheral interface described is not available in the micro-architecture CPU 215, either a companion chip 205 or code may be used in the device to carried-out protocols conversion. An exemplary use for the device of the present invention may integrate one of the following companion IC chips such as: USB-to-Ethernet, SDIO-to-Ethernet, Cardbus-to-Ethernet, PCI-to-Ethernet, CF-to-Ethernet, and ExpressCard-to-Ethernet. CODES

The device could very well fill the need for a solid, easy-to-manage, easy-to-use web hosting server that should be hot-plugged directly onto one of computer peripheral ports and ready for dedicated web hosting services. The device either comprises Linux/GNU or WinCE operating system ported to the CPU complete with web server codes. The device supports CGI, Perl scripting, e-mail via SMTP, POP3 or IMAP4, Domain Name Service, and a user interface (UI) Shared Panel Application (SPA) capable of cross drag-and-drop files between a device and host computer. Other applications such as games, engineering simulation tools, CAD programs, database, could be easily integrated into the device.

The apparatus is the perfect portable, mini Plug-and-Play Web hosting device for those making the transition from shared to dedicate web hosting to get the advantage that all the CPU power and Traffic Bandwidth are dedicated to user own sites. Administration of the device is performed via the Web-Based Control Panel (WBCP) that guides end-user through Host Name, System Administration functions, an Administrator (root) password, Public the web pages, and some basic access rights for a user, etc.

For web publishing, there's a built in, hosting-side, page builder that is user-friendly application for the end-users. One can also use Netscape Composer or other web page development tools such as Microsoft FrontPage or Page Mill to create web sites. Once complete, web pages can be uploaded into the web-hosting device via Web-Based Control Panel (WBCP) application.

With custom coding supported, The device has strong functionality in:
Management
Security
High Performance and Scalability
Applications Compatibility
Web page http authoring and Website construction
Automated DNS zone management

### MANAGEMENT

The Web-Based Control Panel (WBCP) is a graphical user interface application that allows end-users to create separate user accounts for restricted access and configuring the web-hosting device. WBCP application is enhanced with the look-and-feel, easy access to documentation, files and Browser-based. When the device is plugged in one of the computer peripheral ports (USB 10, CF 20, SDIO 30, PCI/PCI-Express 40, Cardbus 50, and ExpressCard 60); WBCP application shall be popped up automatically on computer’s screen and is ready for system administration tasks.

### SECURITY

The device 101, 102, 103, 104, 105, 106 has built-in security features available to the individuals and enterprises from unwanted attacks and undetected vulnerabilities. The built-in security feature restricts users to low privilege access to a well-defined partition of the file system and prevents public clients to access to the device’ files and services that they are not entitled to.

### HIGH PERFORMANCES AND SCALABILITY

The device 101, 102, 103, 104, 105, 106 is architect for extended scalability, efficiency, performance and functionality. It is designed for portable server hosting at host computer peripheral ports using existed Internet connection from host computer. Its main application is for dedicated web hosting services with a variety of configurations. It is extremely versatile in handling volume transactions and high burst traffic. The device 101, 102, 103, 104, 105, 106 can serve around 100 web page requests a second (i.e., greater than 8 million hits a day). It can concurrently handle over 140,000 e-mails, 50,000 file transfers and over 250,000 web page requests a day.

The device 101, 102, 103, 104, 105, 106 contains web sites, e-mail, file sharing, discussion groups, multi-media contents, text indexing and retrieving. It has variety of system memory upgrades capability for 1GB/2GB/4GB/8GB/16GB or higher of FLASH memories 201; and 32MB/64MB/128MB/256MB or higher of SDRAM memories 218.

### APLLICATIONS COMPATIBILITY

Application and Database plug-ins exists for the device such as: games, engineering simulation tools, CAD programs, and database, could be easily integrated into the device with the respective application providers.

### WEB PAGE HTTP AUTHORING AND WEB SITE CONSTRUCTION

Device suite also works with Web Page Authoring programs such as Microsoft's FrontPage, FrontPage Server Extensions and WebDAV. WebDAV is a set of extensions to the HTTP protocol that allows users to collaboratively edit and manage files on remote web servers. This turns the web into a writable medium and is an alternative to file servers for the storage of dynamic documents.

### AUTOMATED DNS ZONE MANAGEMENT

When device 101, 102, 103, 104, 105, 106 is hot-plugged into one of the ports (USB 10, CF 20, SDIO 30, PCI/PCI-Express 40, Cardbus 50, and ExpressCard 60), the device’ zone file information shall be updated automatically to its registered DNS server using existed host Internet connection. Once the DNS update is completed, the device 101, 102, 103, 104, 105, 106 is ready for dedicated web hosting services.

What is Claimed is:

1. A device is a plug-and-play, tiny network-enabled capability device that functions as a host sever when is plugged in one of the following computer ports: USB, SDIO, CF, Cardbus, PCI, PCI-Express, and Expresscard, comprising: a processor that is highly integrated System on a Chip (SoC) included a high-performance low-power Central Processing Unit (CPU), system memories SDRAM, FLASH, codes, and an operating system.

2. A device of claim 1 and further including: a web server code, that turns the device into a Plug-and-Play Web Hosting server at a host computer peripheral port, capable of serving multiple clients at the same time.

3. A device of claim 1,2 and further including: a graphical user interface application, Web-Based Control Panel (WBCP), is for system administrator to create separate user accounts, security for restricted access and configuring the device. When said device is plugged in either one of the computer peripheral ports (USB, CF, SDIO, Cardbus, PCI/PCI-Express, and ExpressCard), the WBCP application shall be popped up on the computer’s screen and is ready for system administration tasks.

4. A device of claim 1 and further including: a Shared Panel Application (SPA) program capable of drag-and-drop files between said device and host computer integrated with various operation systems.

5. A device of claim 1,2,3 and further including: a Universal Serial Bus (USB) port utilized when said device is operating as an USB Plug-and-Play web-hosting server.

6. A device of claim 1,2,3 and further including: a Secure Digital Input and Output (SDIO) port utilized when said device is operating as an SDIO Plug-and-Play web-hosting server.

7. A device of claim 1,2,3 and further including: a Compact Flash (CF) port utilized when said device is operating as a CF Plug-and-Play web-hosting server.

8. A device of claim 1,2,3 and further including: a Cardbus (PCMCIA) port utilized when said device is operating as a Cardbus Plug-and-Play web-hosting server.

9. A device of claim 1,2,3 and further including: a Peripheral Component Interconnect (PCI) port utilized when said device is operating as a PCI Plug-and-Play web-hosting server.

10. A device of claim 1,2,3 and further including: a Peripheral Component Interconnect Express (PCI-Express) port utilized when said device is operating as a PCI-Express Plug-and-Play web-hosting server.

11. A device of claim 1,2,3 and further including: an ExpressCard port utilized when said device is operating as an ExpressCard Plug-and-Play web-hosting server.

12. A device of claim 1 and further including: A fast infrared port utilized when said device is operating as to upload and download data to and from said device.

13. A device of claim 1 and further including: A tiny digital camera utilized when said device is operating to capture still image, video clips, and recording video.

14. A device of claim 5-11 and further including: a WiMax Transceiver module utilized when said device is operating to transmit and receive Internet traffics over the air.

15. A device of claim 5-11 and further including: an Ultra Wide Band (UWB) Transceiver module utilized when said device is operating to transmit and receive Internet traffics over the air.

16. A device of claim 5-11 and further including: a Code Division Multiple Access (CDMA) Transceiver module utilized when said device is operating to transmit and receive Internet traffics over the air.

17. A device of claim 5-11 and further including: a Global System for Mobile Communication (GSM) Transceiver module utilized when said device is operating to transmit and receive Internet traffics over the air.

18. A device of claim 5-11 and further including: a General Package Radio Service (GPRS) Transceiver module utilized when said device is operating to transmit and receive Internet traffics over the air.

19. A device of claim 5-11 and further including: a Wideband Code Division Multiple Access (WCDMA) Transceiver module utilized when said device is operating to transmit and receive Internet traffics over the air.

20. A device of claim 1 and further including: a tiny microphone utilized when said device is operating to record audio.

21. A device of claim 1 and further including: a tiny speaker utilized when said device is operating to playback audio.

22. A device of claim 1 and further including: a non-web server code for an application such as games, engineering simulation tools, CAD programs, and database when said device is operating to run the application at a host computer peripheral port.
